(19) United States
(12) Patent Application Publication
(10) Pub. No.: US 2023/0086236 A1
(43) Pub. Date: Mar. 23, 2023

(54) BIFUNCTIONAL COMPOSITE MEMBRANE AND PREPARATION METHOD AND USE THEREOF, AND METHOD FOR REMOVING PLASTICIZER IN LIQUOR

(71) Applicant: BEIJING TECHNOLOGY AND BUSINESS UNIVERSITY, Beijing (CN)

(72) Inventors: Mingquan HUANG, Beijing (CN); Hong YE, Beijing (CN); Baoguo SUN, Beijing (CN); Jihong WU, Beijing (CN); Fuping ZHENG, Beijing (CN); Yuyu ZHANG, Beijing (CN); Jinyuan SUN, Beijing (CN); Xiaotao SUN, Beijing (CN); Hehe LI, Beijing (CN); Bingyu ZHAO, Beijing (CN); Jingyi DU, Beijing (CN); Chaowei HUO, Beijing (CN)

(21) Appl. No.: 17/439,152

(22) PCT Filed: Feb. 18, 2021
(86) PCT No.: PCT/CN2021/076707

§ 371 Date: Sep. 14, 2021

(30) Foreign Application Priority Data
May 18, 2020 (CN) 202010418003.2

(51) Int. Cl. B01D 69/12; B01D 69/02; B01D 67/00; B01D 71/02; B01D 71/34; B01D 71/70; B01D 71/54; B01D 61/36

(52) U.S. Cl. CPC B01D 69/12; B01D 69/02; B01D 67/00793; B01D 67/00791; B01D 71/0281; B01D 71/34; B01D 71/701; B01D 71/54; B01D 61/362; B01D 61/366; B01D 2325/12; B01D 2323/21819; B01D 2323/2189; B01D 2323/56; B01D 2325/0231; B01D 2325/04; B01D 2323/081; B01D 2313/50; B01D 2313/243; B01D 2313/60; B01D 2313/221

(57) ABSTRACT

The disclosure provides a bifunctional composite membrane, a preparation method and use thereof, and a method for removing a plasticizer in liquor. The bifunctional composite membrane includes a supporting membrane and a dense layer which covers a surface of the supporting membrane, wherein the supporting membrane includes a filtering membrane and an adsorbent, and the adsorbent is dispersed in a pore structure of the filtering membrane.

### CROSS REFERENCE TO RELATED APPLICATION

This application is a US National Stage of International Application No. PCT/CN2021/076707, filed on Feb. 18, 2021, which claims the priority to Chinese Patent Application No. 202010418003.2, entitled “Bifunctional composite membrane and preparation method and use thereof, and method for removing plasticizer in liquor” filed with the China National Intellectual Property Administration on May 18, 2020, the disclosure of which is incorporated by reference herein in its entirety as part of the present application.

### TECHNICAL FIELD

The disclosure relates to the technical field of separation and purification, and particularly to a bifunctional composite membrane and a preparation method and use thereof, and a method for removing a plasticizer in liquor.

### BACKGROUND ART

At present, plasticizer is an important chemical additive widely used in plastics, rubber and other substances, and is also a common endocrine disruptor, which is extremely harmful to the body and has been listed as one of the most common pollutants in the world. Due to environmental pollution, Original grains used for fermentation contain plasticizers, thereby introducing the plasticizer into liquor; in addition, the plasticizer could also be introduced into liquor by contacting with plastic pipes during the production of liquor.

The current methods to reduce the plasticizer in liquor mainly include re-distillation and adsorption. The re-distillation would cause a lot of waste of energy, the adsorption would be affected by the particle size and pore size of the adsorbent, and the adsorbent with a specific pore size is required for a specific plasticizer; at the same time, the adsorbent would also absorb aroma substances in the liquor during the process of adsorbing the plasticizer, which causes a waste of resources and affects the quality of the liquor.

### SUMMARY

In view of this, the present disclosure provides a bifunctional composite membrane and a preparation method and use thereof. The bifunctional composite membrane provided by the present disclosure is used as a pervaporation membrane for the pervaporation separation of the plasticizer from liquor, which could efficiently separate the plasticizer from the liquor, and enrich the aroma substances in the liquor at the same time.

The present disclosure provides a bifunctional composite membrane, comprising a supporting membrane and a dense layer which covers a surface of the supporting membrane;

the supporting membrane comprises a filtering membrane and an adsorbent, and the adsorbent is dispersed in a pore structure of the filtering membrane.

In some embodiments, the material of the dense layer includes one or more selected from the group consisting of polydimethylsiloxane, polyether copolyamide, polyurethane, and polyimide.

In some embodiments, the filtering membrane includes one selected from the group consisting of an ultrafiltration membrane, and a microfiltration membrane.

In some embodiments, the adsorbent includes one or two of a nano-scale activated carbon and a metal-organic frameworks polymer.

In some embodiments, the dense layer has a thickness of 1-100 μm.

The present disclosure also provides a method for preparing the bifunctional composite membrane described in the above technical solution, comprising the following steps:

mixing the adsorbent with water, to obtain a dispersion;

immersing the filter membrane in the dispersion, and subjecting the immersed filter membrane to an ultrasonic treatment and drying in sequence, to obtain a supporting membrane;

forming a membrane of the material of the dense layer on a surface of the supporting membrane, to obtain the bifunctional composite membrane.

In some embodiments, a mass ratio of the adsorbent to water is in the range of 1:(10-500).

In some embodiments, the ultrasonic treatment is performed at an ultrasonic power of 100-400 W for 10-30 min.

In some embodiments, the drying is performed at a temperature of 30-60° C. for 5-12 h.

The present disclosure also provides use of the bifunctional composite membrane described in the above technical solution or the bifunctional composite membrane prepared by the method described in the above technical solution in the removal of plasticizer in liquor.

The present disclosure also provides a method for removing a plasticizer in liquor, comprising the following steps:

providing a pervaporation device; and

using a bifunctional composite membrane as a pervaporation separation membrane, and subjecting the bifunctional composite membrane to a pervaporation separation, to remove the plasticizer in the liquor;

wherein the bifunctional composite membrane is described in the above technical solution or prepared by the method described in the above technical solution.

The present disclosure provides a bifunctional composite membrane, comprising a supporting membrane and a dense layer which covers a surface of the supporting membrane; the supporting membrane comprises a filtering membrane and an adsorbent, and the adsorbent is dispersed in a pore structure of the filtering membrane. The dense layer of the bifunctional composite membrane of the present disclosure could intercept most of the plasticizer, and penetrate ethanol, water and the aroma substances in liquor; the adsorbent in the bifunctional composite membrane could absorb the plasticizer that has not been intercepted by the dense layer, to replenish capture, and improve the removal rate of the plasticizer. In the present disclosure, the aroma substances is difficult to be adsorbed by the adsorbent due to the rapid speed of permeating through the supporting membrane.

In the present disclosure, the bifunctional composite membrane is used as a pervaporation membrane for the pervaporation separation of liquor, which could efficiently intercept the plasticizer in the liquor, and at the same time enrich the aroma substances in the liquor and keep the aroma substances from being lost.

### BRIEF DESCRIPTION OF THE DRAWINGS

FIG. 1 is a schematic diagram of the structure of the pervaporation separation device, in which 1 refers to a feed liquid tank, 2 refers to a feed liquid pump, 3 refers to a flow meter, 4 refers to a membrane cell, 5 refers to an ice bath, 6 refers to a liquid nitrogen cold trap, 7 refers to a vacuum pump, 8 refers to a temperature control device, 9 refers to a pressure gauge, 10 refers to a temperature sensor.

### DETAILED DESCRIPTION OF THE EMBODIMENTS

The present disclosure will be further described below in conjunction with the embodiments and drawings.

The present disclosure provides a bifunctional composite membrane comprising a supporting membrane and a dense layer which covers a surface of the supporting membrane; the supporting membrane comprises a filtering membrane and an adsorbent, and the adsorbent is dispersed in a pore structure of the filtering membrane.

In some embodiments, the filtering membrane includes one selected from the group consisting of an ultrafiltration membrane and a microfiltration membrane, and the ultrafiltration membrane includes a non-woven fabric layer and an ultrafiltration membrane layer coated on a surface of the non-woven fabric layer. In some embodiments, the material of the ultrafiltration membrane layer includes polyvinylidene fluoride and/or polyacrylonitrile, and preferably polyvinylidene fluoride. Under the condition that the material of the ultrafiltration membrane layer is polyvinylidene fluoride and polyacrylonitrile, there is no particular limitation to the ratio of polyvinylidene fluoride to polyacrylonitrile, and they could be mixed in any ratio.

In some embodiments, the microfiltration membrane includes one of a microfiltration membrane with a non-woven fabric substrate and a microfiltration membrane without a non-woven fabric substrate; in some embodiments, the microfiltration membrane with a non-woven fabric substrate includes a non-woven fabric layer and a microfiltration membrane layer coated on the surface of the non-woven fabric layer; in some embodiments, the microfiltration membrane layer includes polyvinylidene fluoride and/or polyacrylonitrile; under the condition that the microfiltration membrane layer is polyvinylidene fluoride and polyacrylonitrile, there is no particular limitation to the ratio of polyvinylidene fluoride to polyacrylonitrile; in some embodiments, the microfiltration membrane without a non-woven fabric substrate is a polytetrafluoroethylene microfiltration membrane.

In some embodiments, the adsorbent includes a nanoscale activated carbon and/or a metal-organic frameworks polymer; in some embodiments, the metal-organic frameworks polymer includes one or more selected from the group consisting of IRMOF, Cu-MOF, MIL series, ZIF series, and UIO series; in some embodiments, the IRMOF includes IRMOF-3, the Cu-MOF includes Cu-BTC, the MIL series includes MIL-53, the ZIF series includes ZIF-8, and the UIO series includes UIO-66. Under the condition that the adsorbent is two or more of the above-mentioned specific adsorbents, there is no particular limitation to the ratio of the specific substances, and they could be mixed in any ratio. In some embodiments, the adsorbent has a particle size of 1 nm to 10 μm, preferably 50 nm to 200 nm, and more preferably 100 nm.

In some embodiments, the material of the dense layer includes one of a polymer and a modified material of the polymer; in some embodiments, the polymer includes one or more selected from the group consisting of polydimethylsiloxane, polyether copolyamide, polyurethane, and polyimide, preferably polydimethylsiloxane; under the condition that the polymer is two or more of the above-mentioned specific polymers, there is no particular limitation to the ratio of the above-mentioned specific polymers, and they could be mixed in any ratio. In some embodiments, the modified material of the polymer is prepared by modifying the polymer with a zeolite molecular sieve. There is no particular limitation to the source of the modified material of the polymer, it may be a commercially available product or prepared by yourself; under the condition that the modified material of the polymer is prepared by yourself, there is no particular limitation to the modification process, any modification process well known to those skilled in the art may be used.

In some embodiments, the dense layer has a thickness of 1 μm to 100 μm, preferably 20 μm to 35 μm, and more preferably 30 μm.

In the present disclosure, the filter membrane plays a supporting role, and the polar groups in the filter membrane could interact with the adsorbent, thereby improving the load stability of the adsorbent. The dense layer could intercept a large part of the plasticizer, and penetrate water, ethanol, and aroma substances in the liquor to separate and remove the plasticizer from the liquor. The adsorbent could absorb the plasticizer that penetrates the dense layer, and play a role of the second-stage interception, further improving the separation efficiency of the plasticizer. In some embodiments, the plasticizer includes one or more selected from the group consisting of dibutyl phthalate (DBP), di(2-ethylhexyl) phthalate (DEHP), and di-n-octyl phthalate (DNOP).

The present disclosure also provides a method for preparing the bifunctional composite membrane described in the above technical solution, comprising the following steps:

mixing the adsorbent with water, to obtain a dispersion;

immersing the filter membrane in the dispersion, and subjecting the immersed filter membrane to an ultrasonic treatment and drying in sequence, to obtain a supporting membrane; and

forming a membrane of the material of the dense layer on a surface of the supporting membrane, to obtain the bifunctional composite membrane.

In the present disclosure, the adsorbent is mixed with water to obtain a dispersion. In some embodiments, a mass ratio of the adsorbent to water is in the range of 1:(10-500), and preferably 1:(100-200). In some embodiments, the mixing is carried out under stirring and ultrasonic conditions in sequence. In some embodiments, the stirring is conducted at a speed of 80-210 rpm, preferably 100-200 rpm, and the stirring is conducted for 20-35 minutes, preferably 30 min. In some embodiments, the ultrasonic is conducted at a power of 100-400 W, preferably 200 W, and the ultrasonic is conducted for 10-30 minutes, preferably 15-20 min. In the present disclosure, the adsorbent and water are mixed under stirring and ultrasonic conditions, so that the adsorbent could be uniformly dispersed in the water, thereby ensuring a uniform dispersion of the adsorbent in the ultrafiltration membrane.

After the dispersion is obtained, the filtering membrane is immersed in the dispersion, and subjected to an ultrasonic treatment and drying in sequence to obtain a supporting membrane. There is no particular limitation to the amount of the dispersion, as long as the filtering membrane could be immersed. In some embodiments, the ultrasonic is conducted at a power of 100-400 W, preferably 200 W, and the ultrasonic is conducted for 10-30 minutes, preferably 15-20 min. In some embodiments, the drying is conducted at a temperature of 30-60° C., preferably 45-50° C., and the drying is conducted for 5-12 h, preferably 6-8 h.

In the present disclosure, the adsorbent enters the pores of the filtering membrane under the action of the ultrasound, and is adhered to the pore wall by intermolecular force, which preferably includes hydrogen bonds, π-π interaction or affinity between groups.

After the supporting membrane is obtained, a membrane is formed by the dense layer material on the surface of the supporting membrane, to obtain a bifunctional composite membrane. In some embodiments, the membrane is formed by casting solution. There is no particular limitation to the process of casting solution, and any conventional process may be used. In some embodiments, casting solution is performed on the surface of the supporting membrane with a scraper, and a coating obtained by casting solution preferably has a thickness of 50-150 μm, specifically 50 μm, 100 μm or 150 μm. In the present disclosure, the thickness of the dense layer may be adjusted by controlling the thickness of the coating obtained by casting solution.

The present disclosure also provides use of the bifunctional composite membrane described in the above technical solution or the bifunctional composite membrane prepared by the method described in the above technical solution in removal of plasticizer in liquor.

The present disclosure also provides a method for removing plasticizer in liquor, comprising the following steps:

providing a pervaporation device;

using a bifunctional composite membrane as a pervaporation separation membrane, and subjecting the bifunctional composite membrane to a pervaporation separation, to remove the plasticizer in the liquor, wherein the bifunctional composite membrane has a dense layer which is oriented towards the liquor entrance side.

The bifunctional composite membrane is described in the above technical solution or prepared by the method described in the above technical solution.

In the present disclosure, there is no particular limitation to the pervaporation separation process, and any pervaporation separation process well known to those skilled in the art may be used. In the present disclosure, there is no particular limitation to the pervaporation device, and any conventional commercially available device may be used.

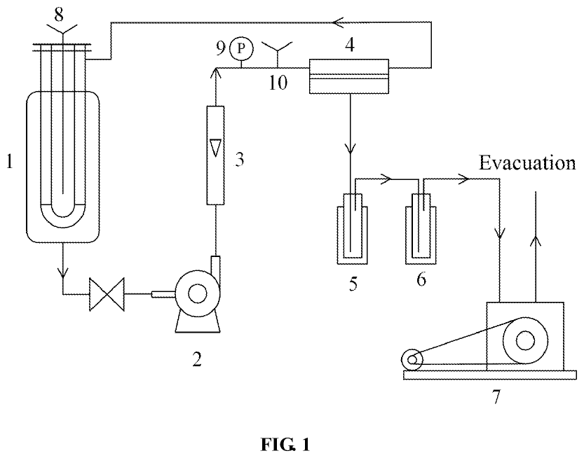

In some embodiments of the present disclosure, the pervaporation device may be a commercially available product, and has a structure shown in FIG. 1. The pervaporation device includes a feed liquid tank 1, a feed liquid pump 2, a flow meter 3, a membrane cell 4, an ice bath 5, a liquid nitrogen cold trap 6 and a vacuum pump 7, which are connected in sequence; a pressure gauge 9 and a temperature sensor 10, which are arranged on a pipeline between the flow meter 3 and the membrane cell 4; and a temperature control device 8, which is arranged inside the feed liquid tank 1 for regulating the temperature of the feed liquid, and comprises a U-shaped heating tube and a temperature sensor. The membrane cell 4 is installed with a bifunctional composite membrane and the bifunctional composite membrane has a dense layer which is oriented towards the liquor entrance side.

In some embodiments of the present disclosure, the pervaporation separation specifically includes: putting the liquor to be separated into the feed liquid tank 1; installing the bifunctional composite membrane in the membrane cell 4; starting the vacuum pump 7; starting the feed liquid pump 2 for the pervaporation separation; transporting the liquor to the membrane cell 4 by the feed liquid pump 2, during which volatile substances in the liquor would pass through the bifunctional composite membrane, and are condensed and recovered in the ice bath 5 and liquid nitrogen cold trap 6, and unvolatile substances in the liquor are reflux to the feed liquid tank 1; circulating the feed liquid between the feed liquid tank 1 and membrane cell 4 under the action of the feed liquid pump 2.

The present disclosure defines the separation end point according to production needs. Specifically, when the recovery rate of the aroma substance reaches 90%, the pervaporation separation could be ended, and the separation could be extended for a period of time if it is desired to completely recover the aroma substance. In the present disclosure, the temperature of the feed liquid is 20-60° C., which is adjusted by the temperature control device 8. In some embodiments of the present disclosure, the vacuum pump 7 is used to set a vacuum environment on the downstream side of the membrane cell 4 to an absolute pressure of the vacuum environment of 0.01-500 Pa. In some embodiments, the pressure of the upstream side of the membrane cell 4 is normal pressure, which is shown by the pressure gauge 9; the temperature of the feed liquid before entering the membrane cell 4 is detected by the temperature sensor 10. In some embodiments of the present disclosure, the feed liquid in the feed liquid tank 1 enters the membrane cell 4 through the flow meter 3 under the action of the feed liquid pump 2, and ethanol and the aroma substances in the liquor in the feed liquid are vaporized, and the resulting vaporized substances enter the downstream side of the membrane cell 4 through the pervaporation membrane, and the unvaporized substances are preferably circulated to the feed liquid tank 1 under the action of the feed liquid pump 2; the vaporized substances enter the downstream side of the membrane cell 4 and are condensed and recovered in the ice bath 5 and the liquid nitrogen cold trap 6. The permeate in the ice bath 5 and the liquid nitrogen cold trap 6 are mixed to obtain the liquor without plasticizer.

In some embodiments of the present disclosure, the placement size of the bifunctional composite membrane is consistent with the bottom size of the membrane cell 4. In some embodiments of the present disclosure, the bifunctional composite membrane has an effective area of 0.22 cm². During the separation process, part of the plasticizer that has not been intercepted by the dense layer of the bifunctional composite membrane would enter the bifunctional composite membrane, and be adsorbed by the adsorbent in the bifunctional composite membrane to further improve the separation efficiency of the plasticizer. In the present disclosure, the bifunctional composite membrane has dual functions of interception and adsorption.

In order to further illustrate the present disclosure, the bifunctional composite membrane provided by the present disclosure and the preparation method and use thereof, and the method for removing plasticizer in liquor are described in detail below in conjunction with examples, but they cannot be understood as a limitation to the protection scope of the present disclosure.

### EXAMPLE 1

1 g of nano-activated carbon (with a particle size of 100 nm) was mixed with 100 g of water, and the resulting mixture was stirred at 200 rpm for 30 minutes, and subjected to an ultrasonic treatment for 15 min at a power of 400 W to obtain a dispersion.

The polyvinylidene fluoride microfiltration membrane with a non-woven fabric substrate was immersed in the dispersion, and subjected to an ultrasonic treatment at a power of 400 W for 15 minutes, and then dried at 50° C. for 12 hours, to obtain a supporting membrane.

The polydimethylsiloxane modified by zeolite molecular sieves was casted to the surface of the supporting membrane and scraped by a scraper to obtain a bifunctional composite membrane, wherein the bifunctional composite membrane has a dense layer with a thickness of 30 μm.

The pervaporation separation device shown in FIG. 1 was used for pervaporation separation, and 1000 mL of a commercially available brand of liquor with an ethanol concentration of 58% by volume (which was added with additional plasticizers, i.e., dibutyl phthalate, di(2-ethylhexyl) phthalate and di-n-octyl phthalate, and detected by GC-MS, having the concentration of dibutyl phthalate of 3 mg/L, the concentration of di(2-ethylhexyl) phthalate of 6 mg/L, the concentration of di-n-octyl phthalate of 1mg/L, and the total concentration of the plasticizers of 10 mg/L) was put into the feed liquid tank 1, and the bifunctional composite membrane with an effective area of 0.22 cm² was installed in the membrane cell 4 as a pervaporation separation membrane, then the temperature of the liquor was adjusted to 50° C. by the temperature control device 8, and the absolute vacuum pressure on the downstream side of the membrane cell 4 was adjusted to 100 Pa by the vacuum pump 7, and the liquor was circulated between the feed liquid tank and the membrane cell for pervaporation separation by the feed liquid pump 2. After 5 hours of pervaporation separation, the permeate in the ice bath 5 and the liquid nitrogen cold trap 6 were mixed to obtain the liquor without plasticizer.

The content of the aroma substances in the raw liquor was analyzed by GC-MS, and the results are listed in Table 1. During the pervaporation separation process, the content of the aroma substances in the permeate was detected per 1 hour, and the results are listed in Table 1. The total concentration of the plasticizer in the permeate was detected per 1 hour by GC-MS method, and the results are listed in Table 2. At the same time, the interception rate of the plasticizer was calculated, and the results are listed in Table 2; the interception rate=1−(total concentration of the plasticizer in permeate/total concentration of the plasticizer in raw material side feed liquid).

TABLE 1
The content of the aroma substance in liquor
before and after pervaporation separation

| | | Content (%) | | | | | |
|---|---|---|---|---|---|---|---|
| | | Raw | Pervaporation separation time | | | | |
| No. | Component | liquor | 1 h | 2 h | 3 h | 4 h | 5 h |
| 1 | Ethyl acetate | 26.83 | 21.69 | 23.04 | 24.64 | 23.56 | 23.7 |
| 2 | 1-propanol | 0.28 | 0.42 | 0.9 | 0.43 | 0.39 | 0.44 |
| 3 | 2-methyl-1-propanol | 0.18 | 0.54 | 0.53 | 0.58 | 0.56 | 0.54 |
| 4 | Ethyl lactate | 25.69 | 11.67 | 11.35 | 12.12 | 11.56 | 11.78 |
| 5 | Ethyl caprylate | — | 1.05 | 1.27 | 1.47 | 1.3 | 1.52 |
| 6 | Furfural | 1.79 | 4.43 | 4.03 | 4.46 | 4.25 | 4.15 |
| 7 | Acetic acid | 10.46 | 1.99 | 2.61 | 2.08 | 2.55 | 2.57 |
| 8 | DL-2-hydroxy-4-methylvaleric | 0.5 | 0.25 | 0.23 | 0.26 | 0.23 | 0.25 |
| | acid ethyl ester | | | | | | |
| 9 | 2,3-butanediol | 1.27 | — | — | — | — | — |
| 10 | Diethyl succinate | 0.38 | 0.06 | 0.09 | 0.08 | 0.08 | 0.09 |
| 11 | Methoxybenoxime | 4.6 | 2.18 | 2.88 | 2.07 | 2.15 | 1.87 |
| 12 | Phenethyl alcohol | 0.94 | 0.12 | 0.16 | 0.17 | 0.16 | 0.18 |
| 13 | Phenol | 2.31 | 1.81 | 1.44 | 1.43 | 1.31 | 1.37 |
| 14 | Glycerinum | 0.45 | — | — | — | — | — |

TABLE 2
The concentration and the interception rate of the plasticizer
in liquor after pervaporation separation

| Pervap- | | Total concentration | Total |
|---|---|---|---|
| oration | Total concentration | of the plasticizer in | interception |
| separation | of the plasticizer in | raw material side | rate of |
| time (h) | permeate (mg/L) | feed liquid (mg/L) | plasticizer (%) |
| 1 | 0.3409 | 15.5662 | 97.81 |
| 2 | 0.3017 | 14.8474 | 97.968 |
| 3 | 0.2969 | 14.4126 | 97.94 |
| 4 | 0.3365 | 14.2585 | 97.64 |
| 5 | 0.2829 | 16.2586 | 98.26 |

From the data in Table 1 and Table 2, it can be seen that the bifunctional composite membrane provided by the present disclosure can be used as a pervaporation separation membrane to remove the plasticizer in the liquor, which can intercept the aroma substances in the liquor, and the interception rate of the plasticizer in the liquor after the pervaporation separation is 97.64-98.26%.

### EXAMPLE 2

1 g of ZIF-8 (with a particle size of 50 nm) was mixed with 100 g of water, and the resulting mixture was stirred at 200 rpm for 20 minutes, and subjected to an ultrasonic treatment for 20 min at a power of 200 W, to obtain a dispersion.

The polyvinylidene fluoride ultrafiltration membrane was immersed in the dispersion, and subjected to an ultrasonic treatment at a power of 100 W for 15 minutes, and then dried at 60° C. for 8 hours, to obtain a supporting membrane which loaded with adsorbent.

The polyurethane was casted to the surface of the supporting membrane and scraped by a scraper to obtain a bifunctional composite membrane, wherein the bifunctional composite membrane has a dense layer with a thickness of 20 μm.

The pervaporation separation device shown in FIG. 1 was used for pervaporation separation, and 1000 mL of a commercially available brand of liquor with an ethanol concentration of 58% by volume (which was added with additional plasticizers, i.e., dibutyl phthalate, di(2-ethylhexyl) phthalate and di-n-octyl phthalate, and detected by GC-MS, having the concentration of dibutyl phthalate of 4 mg/L, the concentration of di(2-ethylhexyl) phthalate of 4 mg/L, the concentration of di-n-octyl phthalate of 2 mg/L, and the total concentration of plasticizers of 10 mg/L) was put into the feed liquid tank 1, and the bifunctional composite membrane with an effective area of 0.22 cm² was installed in the membrane cell 4 as a pervaporation separation membrane, then the temperature of the liquor was adjusted to 40° C. by the temperature control device 8, and the absolute vacuum pressure on the downstream side of the membrane cell 4 was adjusted to 20 Pa by the vacuum pump 7, and the liquor was circulated between the feed liquid tank and the membrane cell for pervaporation separation by the feed liquid pump 2. The total concentration of the plasticizer in the permeate was detected per 1 hour by GC-MS method, and the results are listed in Table 3. At the same time, the interception rate of the plasticizer was calculated, and the results are listed in Table 3; the interception rate=1−(total concentration of the plasticizer in permeate/total concentration of the plasticizer in raw material side feed liquid).

TABLE 3
The concentration of the plasticizer and the interception rate
of the plasticizer in liquor after pervaporation separation

| Pervap- | | Total concentration | Total |
|---|---|---|---|
| oration | Total concentration | of the plasticizer in | interception |
| separation | of the plasticizer in | raw material side | rate of |
| time (h) | permeate (mg/L) | feed liquid (mg/L) | plasticizer (%) |
| 1 | 0.459 | 12.5662 | 96.3473 |
| 2 | 0.5042 | 11.8474 | 95.7442 |
| 3 | 0.398 | 13.4126 | 97.0326 |
| 4 | 0.4652 | 12.2585 | 96.2051 |
| 5 | 0.3268 | 12.2586 | 97.3341 |

From the data in Table 3, it can be seen that the bifunctional composite membrane provided by the present disclosure can be used as a pervaporation separation membrane to remove the plasticizer in the liquor, and the interception rate of the plasticizer in the liquor is 95.7442-97.3341%.

### EXAMPLE 3

1 g of MIL-53 (with a particle size of 50 nm) was mixed with 500 g of water, and the resulting mixture was stirred at 100 rpm for 20 minutes, and subjected to an ultrasonic treatment for 15 min at a power of 400 W to obtain a dispersion.

The polytetrafluoroethylene microfiltration membrane was immersed in the dispersion, and subjected to an ultrasonic treatment at a power of 200 W for 20 minutes, and then dried at 50° C. for 8 hours to obtain a supporting membrane which loaded with adsorbent.

The polyether copolyamide was casted to the surface of the supporting membrane and scraped by a scraper to obtain a bifunctional composite membrane, wherein the bifunctional composite membrane has a dense layer with a thickness of 25 μm.

The bifunctional composite membrane prepared in Example 3 can be used as a pervaporation separation membrane to remove the plasticizer in the liquor, and the interception rate of the plasticizer in the liquor was similar to the results of Example 1 or 2.

The description of the above examples is only used to help to understand the method and the core idea of the present disclosure. It should be pointed out that for those skilled in the art, without departing from the principle of the present disclosure, several improvements and modifications could be made according to the present disclosure, and these improvements and modifications also fall within the protection scope of the claims of the present disclosure. Various modifications to these examples are obvious to those skilled in the art, and the general principles defined herein could be implemented in other embodiments without departing from the spirit or scope of the present disclosure. Therefore, the protection scope of the present disclosure would not be limited to such examples shown herein, but should be the widest scope consistent with the principles and novel features disclosed herein.

1. A bifunctional composite membrane, comprising a supporting membrane and a dense layer which covers a surface of the supporting membrane;
the supporting membrane comprises a filtering membrane and an adsorbent, and the adsorbent is dispersed in a pore structure of the filtering membrane.

2. The bifunctional composite membrane of claim 1, wherein a material of the dense layer comprises one of a polymer and a modified material of a polymer;
the polymer comprises one or more selected from the group consisting of polydimethylsiloxane, polyether copolyamide, polyurethane, and polyimide; the modified material of the polymer is obtained by modifying the polymer by using a zeolite molecular sieve.

3. The bifunctional composite membrane of claim 1, wherein the filtering membrane comprises one of an ultrafiltration membrane and a microfiltration membrane;
the adsorbent comprises one or two of a nano-scale activated carbon and a metal-organic frameworks polymer.

4. The bifunctional composite membrane of claim 3, wherein the adsorbent has a particle size of 1 nm to 10 μm.

5. The bifunctional composite membrane of claim 3, wherein the metal-organic frameworks polymer comprises one or more selected from the group consisting of IRMOF, Cu-MOF, MIL series, ZIF series, and UIO series.

6. The bifunctional composite membrane of claim 1, wherein the dense layer has a thickness of 1-100 μm.

7. A method for preparing the bifunctional composite membrane of claim 1, comprising the following steps:
mixing the adsorbent with water, to obtain a dispersion;
immersing the filter membrane in the dispersion, and subjecting the immersed filter membrane to an ultrasonic treatment and drying, to obtain a supporting membrane; and
forming a membrane of the material of the dense layer on the surface of the supporting membrane, to obtain the bifunctional composite membrane.

8. The method of claim 7, wherein a mass ratio of the adsorbent to water is in the range of 1:(10-500.)

9. The method of claim 7, wherein the ultrasonic treatment is performed at an ultrasonic power of 100-400 W for 10-30 min.

10. The method of claim 7, wherein the drying is performed at a temperature of 30-60° C. for 5-12 h.

11. (canceled)

12. A pervaporation device, comprising a feed liquid tank, a feed liquid pump, a flow meter, a membrane cell, an ice bath, a liquid nitrogen cold trap and a vacuum pump, which are connected in sequence; a pressure gauge and a temperature sensor, which are arranged on the pipeline between the flow meter and the membrane cell; and a temperature control device, which is arranged inside the feed liquid tank and comprises a U-shaped heating tube and a temperature sensor;
the membrane cell is installed with a bifunctional composite membrane, and the bifunctional composite membrane has a dense layer which is oriented towards a liquor entrance side;
the bifunctional composite membrane is the bifunctional composite membrane of claim 1.

13. The pervaporation device of claim 12, wherein the vacuum pump is used to set a vacuum environment on a downstream side of the membrane cell to an absolute pressure of the vacuum environment of 0.01-500 Pa.

14. (canceled)

15. (canceled)
